(19) United States
(12) Patent Application Publication
(10) Pub. No.: US 2016/0286020 A1
(43) Pub. Date: Sep. 29, 2016

(54) SYSTEM FOR DETECTING THAT A USER HAS GONE AWAY FROM HIS OR HER OWN MOBILE DEVICE

(71) Applicant: Giovanni FORNARI, Taranto, TA (IT)

(72) Inventor: Giovanni FORNARI, Taranto, TA (IT)

(21) Appl. No.: 14/778,396

(22) PCT Filed: Mar. 14, 2014
(86) PCT No.: PCT/IB2014/059782

§ 371 Date: Sep. 18, 2015

(30) Foreign Application Priority Data
Mar. 18, 2013 (IT) TO2013A000210

(51) Int. Cl. H04M 1/725; G08B 21/24

(52) U.S. Cl. CPC H04M 1/7253; G08B 21/24

(57) ABSTRACT

A system for detecting that a user has gone away from his or her own mobile device comprises a mobile device (20) and a device (10) that may be carried or worn by a user. The mobile device (20) comprises an electronic circuit (204), for handling the mobile communication, supplied by a battery (206). The system comprises a transmitter circuit (202) coupled to the mobile device (20), supplied by the battery (206) of the mobile device (20). The transmitter circuit (202) periodically transmits a predetermined signal. The system, further comprises a receiver circuit (102) integrated in the device (10), and configured for monitoring transmission of the transmitter circuit (202) for detecting the presence or absence of the predetermined signal and, in the case where the absence of the predetermined signal is detected, generating an alarm signal. Preferably, the system comprises a power supply (40) with two cables, in such a way as to recharge simultaneously the battery (106) of the device (10) and the battery (206) of the mobile device (20).

### TECHNICAL FIELD

The present invention relates to a system for detecting that a user has gone away from his or her own mobile device, i.e., an anti-loss system.

### TECHNOLOGICAL BACKGROUND

The system for detecting that a user has gone away from his or her own mobile device, such as for example a cellphone, is an electronic system based upon the communication between two communication systems that are coupled, respectively, to a mobile device and to a device carried by the user.

For instance, the Italian patent application No. MI2005A001783 describes a method of radio-identification by means of an RFID (Radio-Frequency IDentification) transponder that envisages that a portable master device controls objects of personal use on which a transponder is glued. For instance, the master device may be a bracelet, necklace, or key-ring, and the personal objects may be, for example, a wallet, a purse, a handbag, a bankcard, or a cellphone. In particular, the master device starts a scan of the transponder at intervals of two seconds by including its own unique identification code in the scanning signal, and only those transponders that have received correctly the scanning signal coming from the master device the unique code of which corresponds to the one stored answer.

In general, there are known communication systems between two or more devices that are based upon a unidirectional or bidirectional communication channel.

One of the main problems of the above systems for detecting that the user has gone away is represented by power supply of the radiofrequency communication systems.

### OBJECT AND SUMMARY

In the system described in the Italian patent application No. MI2005A001783, the RFID transponder that is coupled to the object could be a passive transponder. However, in this case, the system carried by the user should supply a high transmitting power to supply the passive transponders and consequently should be equipped with a large battery or some other accumulator of energy. However, this would mean that the device carried by the user would need to have a large case or would have to be recharged after short lapses of time.

The object of the invention is to provide solutions that overcome one or more of the drawbacks outlined above.

With a view to achieving the aforesaid object, the subject of the invention is a system for detecting that a user has gone away from his or her own mobile device that presents the characteristics specified in claim 1. Further advantageous characteristics of the invention form the subject of the dependent claims.

The claims form an integral part of the technical teaching provided herein in relation to the invention.

In particular, modern mobile devices are already equipped with a large battery pack. Consequently, unlike what is proposed in the Italian patent application No. MI2005A001783, the present description proposes:

a) using directly the battery of the mobile device as source of energy for the transmitter (or transceiver) coupled to the mobile device; and

b) configure the transmitter (or transceiver) coupled to the mobile device as master, i.e., as initiator of the communication.

In fact, in this way, the mobile device can transmit periodically a unique code of its own, and the device carried by the user merely has to detect transmission of the code. Consequently, in this case, it is sufficient for the device carried by the user to have a small battery pack, which makes it possible to create objects that are more attractive.

Consequently, in various embodiments, the system comprises a mobile device and a device that can be carried or worn by a user. Typically, the mobile device comprises an electronic circuit that handles the mobile communication, and the electronic circuit is supplied via a battery that is incorporated in the mobile device.

In various embodiments, the system further comprises a transmitter circuit and a receiver circuit. The transmitter circuit is coupled to the mobile device. In particular, the transmitter circuit is connected to the battery of the mobile device and periodically transmits a predetermined signal.

Instead, the receiver circuit is integrated in the device carried by the user. In various embodiments, the receiver circuit monitors transmission by the transmitter circuit and detects the presence or absence of the predetermined signal. In the case where absence of the predetermined signal is detected, the receiver circuit generates an alarm signal. This signal may be used, for example, for driving an acoustic transducer, a light transducer, and/or a vibration transducer.

In various embodiments, both the mobile device and the device carried by the user comprise a charger circuit for charging the respective batteries. In this case, the connector of the device carried by the user may be compatible with the connector of the mobile device so that one and the same power supply may be used for charging both of the devices.

In various embodiments, the system comprises a power supply with two cables so that the batteries of the two devices may be charged simultaneously.

### BRIEF DESCRIPTION OF THE ANNEXED DRAWINGS

Various embodiments will now be described purely by way of non-limiting example with reference to the annexed drawings, wherein:

FIGS. 1 and 2 show an embodiment of a detection system according to the present description.

### DETAILED DESCRIPTION OF EMBODIMENTS

Illustrated in the ensuing description are various specific details aimed at providing an in-depth understanding of the embodiments. The embodiments may be provided without one or more of the specific details, or with other methods, components, materials, etc. In other cases, known structures, materials or operations are not illustrated or described in detail so that various aspects of the embodiments will not be obscured.

Reference to “an embodiment” or “one embodiment” in the framework of the present description is intended to indicate that a particular configuration, structure, or characteristic described in relation to the embodiment is comprised in at least one embodiment. Hence, phrases such as “in an embodiment” or “in one embodiment” that may be present in various points of this description do not necessarily refer to one and the same embodiment. Furthermore, particular conformations, structures or characteristics may be combined in any adequate way in one or more embodiments.

The references used herein are provided only for convenience and hence do not define the sphere of protection or the scope of the embodiments.

As mentioned previously, the object of the present description is a system for detecting that a user has gone away from his or her own mobile device, i.e., an anti-loss system.

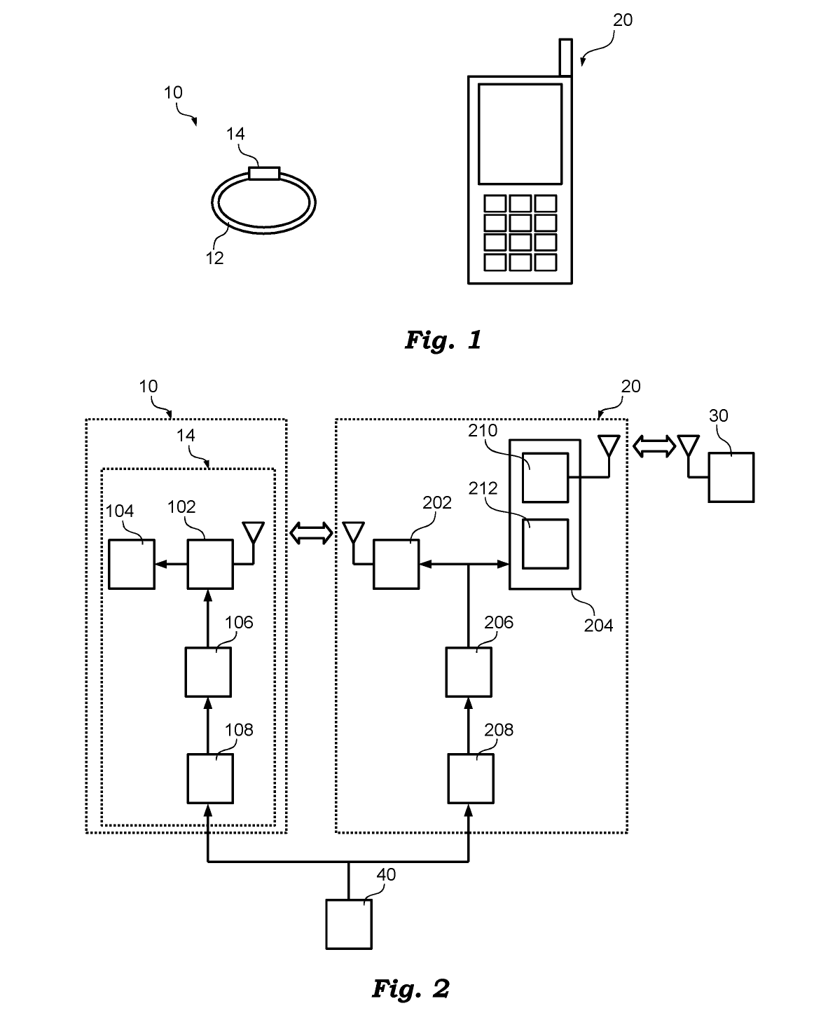

FIG. 1 shows the general architecture of a system for detecting that a user has gone away from his or her own mobile device according to the present description.

In the embodiment considered, the system comprises a mobile device, such as for example a cellphone 20, and a device 10 carried by a user.

In the embodiment considered, the device 10 carried by a user is a bracelet 10 that comprises a strap 12 and an electronic circuit 14.

In this context, FIG. 2 is a block diagram that illustrates the main blocks of the device 10 and of the cellphone 20.

In general, the mobile device 20 comprises an electronic circuit 204 that handles the mobile communication of the device 20. For instance, typically, the mobile device 20 comprises for this purpose a processor 212 and a radio interface 210, such as for example a GSM (Global System for Mobile Communications) transceiver or UMTS (Universal Mobile Telecommunications System) transceiver, for mobile communication with a base station 30.

In the embodiment considered, the cellphone 20 has associated to it, i.e., coupled or integrated, a transmitter 202, and the device 10 comprises a receiver 102.

Consequently, in the embodiment considered, the device 202 can transmit data to the receiver 102. In general, transceivers may also be used instead of the transmitter 202 and of the receiver 102; i.e., the communication between the transmission circuits 202 and 102 may be unidirectional or else bidirectional. For instance, in one embodiment, the circuits 102 and 202 are based upon an integrated circuit constituted by a microcontroller unit MCU and a 2.4-GHz transceiver (SoC—System on Chip). This device enables development of an electronic circuit having particularly contained dimensions. The protocol underlying the communication system could, for example, be the standard IEEE 802.15.4 on which some of the applicational functions of ZigBee may be used. In general, other short-range and low-transmission-power radiofrequency communication systems may also be used. For instance, communication systems that are based directly upon an amplitude or frequency modulation may also be used, or more complex systems may also be employed, such as for example Bluetooth or ZigBee.

In the embodiment considered, operation of the circuits 102 and 202 is synchronized. Normally, both of the circuits are in standby mode, i.e., a low-energy-consumption mode in which the high-frequency transceiver circuit is deactivated. After certain temporary waiting intervals, for example every 100-500 ms, both of the circuits 102 and 202 are activated and the circuit 202 transmits a predetermined signal to the circuit 102. For instance, in a preferred embodiment, the circuit 202 transmits a unique code that is stored also in the receiver circuit 102. In a currently preferred embodiment, encoding is based upon the MAC (Medium Access Control) address with which a ZigBee transceiver is uniquely equipped. However, the IMEA (International Mobile Station Equipment Identity) code of the cellphone 20 could also be used directly, i.e., the unique code associated to the communication interface 210.

Consequently, in one embodiment, the receiver circuit 102 is configured for activating an alarm signal when it does not detect the signal transmitted by the transmitter circuit 202.

For instance, in one embodiment, the receiver circuit 102, once turned on, sets itself in listening mode and resets an internal watchdog once it has received the predetermined signal from the transmitter 202. If the watchdog remains not reset for two seconds, or in general a time equal to at least the time of a waiting interval, the receiver circuit 102 activates the alarm signal. For instance, this alarm signal can activate a transducer 104, such as for example an acoustic transducer, a light transducer, and/or a vibration transducer.

In one embodiment, the receiver circuit 102 is also configured for calculating the distance between the circuits 102 and 202. For instance, the circuit 102 can analyse for this purpose the power of the signal received. Consequently, the alarm signal may be activated when the distance between the circuits 102 and 202 exceeds a given threshold, which could also be settable by the user. For instance, in this case, the device 10 could comprise also a light indicator, such as for example a low-power LED. This LED could indicate whether the circuits 102 and 202 are in radio visibility by emitting pulses that signal the state by varying the flashing frequency.

Consequently, in the case where the receiver circuit 102 is able to detect the signal transmitted by the transmitter circuit 202, the radiofrequency interface of the circuit 102 may be activated only for a short time interval, which typically is less than 10 ms. Consequently, the energy consumption of the circuit 102 is very low, and the circuit 14 may be integrated in a bracelet that may be worn on the wrist. In general, instead of a bracelet, also another object or accessory that may be worn by the user can be used.

Consequently, it is sufficient for the receiver circuit 102 to be connected to a small rechargeable battery 106, such as for example a rechargeable lithium battery, and to a charger circuit 108. For instance, also in this case a light indicator, such as for example a LED, may be provided, which signals the state of charge.

As mentioned previously, the receiver circuit 102 is configured for detecting the signal transmitted by the circuit 202 and comparing it with a code stored within the circuit 102. For this purpose, the devices and 20 may be pre-configured and sold together. Instead, in one embodiment, the device 10 may also be sold separately, which is advantageous if the circuit 202 is integrated directly in the cellphone 20 and the function for detecting that the user has gone away is sold only as optional. In this case, the receiver circuit 102 may be equipped with a key that enables coupling of a cellphone 20, i.e., a transmitter circuit 202, with its code, to the receiver circuit 102. For this purpose, the receiver circuit 102, once turned on, stores the first code received.

Instead, the transmitter circuit 202 is of smaller dimensions than the circuit 14 because no transducers are envisaged. Furthermore, in the embodiment considered, the transmitter circuit 202 does not comprise a battery of its own but is directly connected to the battery 206 of the mobile device 20.

In one embodiment, switching between the operating states of the transmitter circuit 202 is independent of switching between the operating states of the electronic circuit 204 of the cellphone 20. Consequently, the circuit 202 could always remain turned on or be equipped with a separate switch that enables turning-on and turning-off of the circuit 202 irrespective of the state of operation of the circuit 204. Consequently, operation of the transmitter 202 and of the receiver 102 differs considerably from operation of a classic Bluetooth system, which can only function when also the cellphone is turned on. Instead, in the embodiment considered, the transmitter 202 can also remain turned on when the circuit 204 is turned off and/or in standby mode (the so-called “offline” or “airplane” mode), in which the radio interfaces of the circuit 204, such as for example the interface 210, are turned off.

Consequently, the transmitter circuit 202 is preferably:

integrated directly in the mobile device 20 already in the manufacturing stage;

connected to the same battery 206 that supplies the mobile device 20; and

able to operate independently of operation of the circuit 204 of the cellphone.

However, in general switching between the operating states of the transmitter 202 may also be synchronized with switching between the operating states of the circuit 204. For instance, one and the same switch could be used for turning on the circuit 204 and the transmitter 202, or also the transmitter could be turned off when the circuit 204 activates the standby mode.

In either case, operation of the circuit 202 could be configurable via the circuit 204 of the cellphone 20, for example by means of an application that is executed by the processor 212. Preferably, also operation of the circuit 102 could be configurable, for example by control means that are sent through the transmitter circuit 202 to the receiver circuit 102. For instance, in this way, the maximum distance between the two devices 10 and 20 that activates the alarm signal could be configurable, or else the step of coupling between the devices 10 and 20 could be managed via an application of the cellphone 20.

Consequently, the systems described herein differ considerably from the classic traceability systems that are provided in modern smartphones. In fact, these traceability systems, in addition to presenting various limits—such as, for example, the fact that the system functions only when the cellphone is turned on—, also present the peculiarity of being an a posteriori instrument in the sense that they are used after the cellphone has been mislaid.

Instead, the solution for detecting that a user has gone away from his or her own cellphone described herein is not an application for smartphones, nor a device that can be applied a posteriori. The systems described herein enable detection of the moment when the item is mislaid, which means that the cellphone can be traced immediately. Furthermore, the system is not based upon a software application and consequently is able to function always and also with less advanced mobile devices. Preferably, the cellphone is produced directly with the transmitter circuit 202 incorporated, and the receiver circuit 102 is inserted into the bracelet sold as accessory or preferably together with the cellphone.

As mentioned previously, both the device 10 and the mobile device 20 are equipped with a battery charger (108 and 208) for charging the respective batteries (106 and 206).

For this reason, in one embodiment, the device 10 comprises a connector that is compatible with the external power supply 40 sold with the mobile device 20. For instance, a mini-USB connector may be used for this purpose. Consequently, a single power supply 40 for both of the devices 10 and 20 may be sufficient.

However, in this latter case just one of the devices 10 and 20 can be recharged at a time. To obviate this problem, in a preferred embodiment, a power supply 40 is used that comprises two separate cables that enable simultaneous charging of the devices 10 and 20.

Consequently, the solutions described herein present numerous advantages, some of which are listed below:

thanks to the pre-configuration or simple association of two circuits 102 and 202, the system functions almost instantaneously in a simple, effective, and secure way;

an additional battery and a further charger circuit for the transmitter circuit 202 are not necessary;

the battery 106 of the device 10 may be of small size, because the circuit 102 only has to monitor the signal transmitted by the transmitter circuit 202 periodically;

an additional power supply for the device 10 is not required, because the battery 106 may be recharged by means of the power supply 40 of the cellphone 20; and

the battery 106 of the device 10 and the battery 206 of the mobile device 20 may be recharged simultaneously by means of the power supply 40 of the cellphone 20 equipped with two separate cables.

Of course, without prejudice to the principle of the invention, the details of construction and the embodiments may vary widely with respect to what has been described and illustrated herein purely by way of example, without thereby departing from the scope of the present invention, as defined by attached claims.

1. A system for detecting that a user has gone away from his or her own mobile device, comprising a mobile device and a device that may be carried by said user, wherein said mobile device comprises an electronic circuit that handles the mobile communication of said mobile device, wherein said electronic circuit is supplied by a battery of said mobile device, said system being characterized in that it comprises:
a transmitter circuit coupled to said mobile device, wherein said transmitter circuit is supplied by said battery of said mobile device, and wherein said transmitter circuit periodically transmits a predetermined signal; and
a receiver circuit integrated in said device, wherein said receiver circuit is configured for:
monitoring transmission of said transmitter circuit and detecting the presence or absence of said predetermined signal; and
in the case where the absence of said predetermined signal is detected, generating an alarm signal.

2. The detection system according to claim 1, wherein:
said mobile device comprises a charger circuit for recharging said battery of said mobile device;
said device comprises a battery and a charger circuit for recharging said battery of said device; and
said charger circuit of said mobile device and said charger circuit of said device have respective connectors associated to them.

3. The detection system according to claim 2, wherein the connector of said device is identical to the connector of said mobile device so that one and the same power supply may be used for charging said battery of said device or said battery of said mobile device.

4. The detection system according to claim 2, wherein said system comprises a power supply with two cables so that said power supply is designed to recharge simultaneously said battery of said device and said battery of said mobile device.

5. The detection system according to claim 1, wherein said device comprises an acoustic transducer, a light transducer, and/or a vibration transducer that are/is activated by said alarm signal.

6. The detection system according to claim 1, wherein said predetermined signal is a unique code.

7. The detection system according to claim 1, wherein said transmitter circuit and said receiver circuit, form a short-range and low-transmitting-power radiofrequency communication system.

8. The detection system according to claim 7, wherein said communication system is based upon the communication standard IEEE 802.15.4.

9. The detection system according to claim 1, wherein:
said predetermined signal is preconfigured in said transmitter circuit and in said receiver circuit; or
said receiver circuit has associated to it a key that enables coupling of said receiver circuit to a transmitter circuit, wherein, once said key has been pressed, said receiver circuit stores the signal received from said transmitter circuit.

10. The detection system according to claim 1, wherein:
switching between the operating states of said transmitter circuit is independent of switching between the operating states of said electronic circuit; or
at least one switching between the operating states of said transmitter circuit is synchronized with a switching between the operating states of said electronic circuit.
